(19) United States
(12) Patent Application Publication
(10) Pub. No.: US 2011/0207090 A1
(43) Pub. Date: Aug. 25, 2011

(54) TRAINING ARRANGEMENT FOR TRAINING FLIGHT ATTITUDES OF AN AIRCRAFT CAPABLE OF VERTICAL TAKEOFF AND/OR VERTICAL LANDING

(75) Inventor: ANDREAS MARGREITER, Wien (AT)

(73) Assignee: Wunderwerk Digitale Medien Produktion GmbH, Wien (AT)

(21) Appl. No.: 13/011,265

(22) Filed: Jan. 21, 2011

Related U.S. Application Data
(60) Provisional application No. 61/317,034, filed on Mar. 24, 2010.

(30) Foreign Application Priority Data
Jan. 22, 2010 (AT) A 84/2010

(51) Int. Cl. G09B 9/08

(52) U.S. Cl. 434/37

(57) ABSTRACT

A training arrangement for training flight attitudes of an aircraft capable of vertical takeoff and/or vertical landing includes at least one first support for at least one subject, a ground contact device at least indirectly connected with the first support, a movement device constructed as a robot with serial kinematics and substantially rigidly connected with the first support for moving the first support in at least six three-dimensional degrees of freedom, at least one control device configured for at least indirect interaction of the subject with the movement device, and a movable platform from which the ground contact device can be lifted off or onto which the ground contact device can be set down. The platform can be automatically adjusted in a predetermined fashion.

### CROSS-REFERENCES TO RELATED APPLICATIONS

This application claims the benefit of prior filed U.S. Provisional Application No. 61/317,034, filed Mar. 24, 2010, pursuant to 35 U.S.C. 119(e).

This application further claims the priority of Austrian Patent Application, Serial No. A 84/2010, filed Jan. 22, 2010, pursuant to 35 U.S.C. 119(a)-(d),

The contents of U.S. provisional Application No. 61/317,034 and Austrian Patent Application, Serial No. A 8412010 are incorporated herein by reference in its entirety as if fully set forth herein.

### BACKGROUND OF THE INVENTION

The present invention relates to a training arrangement for the training of flight attitudes of an aircraft capable of vertical takeoff and/or vertical landing. The invention also relates to a method for training flight attitudes of an aircraft capable of vertical takeoff and/or vertical landing.

The following discussion of related art is provided to assist the reader in understanding the advantages of the invention, and is not to be construed as an admission that this related art is prior art to this invention.

Simulators for flight simulation, which allow the simulation of the movement of an object to be simulated, for example of an aircraft or a helicopter, in six three-dimensional degrees of freedom, are known in the art. Such simulators are configured as hexapods or so-called Stewart platform, which support a model of the cockpit of an aircraft to be simulated. The windows are surrounded by display screens or projection screens, on which images of the surroundings matching the respective simulation condition are displayed.

Disadvantageously, such flight simulators are very large, heavy, expensive and inflexible. A certain type of a flight simulator is only capable of simulating a single type of aircraft, whereby the full functionality and, in particular, the full movement of the actual aircraft typically cannot be simulated, because conventional flight simulators only have limited actual mobility. Such conventional flight simulators are already quite limited at the maximum actually attainable banking as well as at the actually attainable angle of climb or angle of attack. The representation of the surroundings suggests to the user much greater values for the respective angles than the actual banking or angle of climb or attack. In addition, the acceleration attainable with conventional flight simulators is very limited. This has been shown to cause nausea in the subjects because the actual banking and/or or acceleration detected by the human sensory organs do not match the visually detected or displayed banking and/or acceleration. Such flight simulators are typically only accessible to a very limited group of people due to their complexity and high cost.

Conventional flight simulators have also the disadvantage that in particular critical flight attitudes of aircraft capable of vertical takeoff and/or vertical landing, for example takeoffs and/or landings, cannot be so realistically simulated that this would enable an accurate training of the corresponding flight situation. More particularly, conventional flight simulators do not allow a realistic training of takeoffs and/or landings on moving ground, for example on a landing pad on a ship.

It would therefore be desirable and advantageous to address this problem and to obviate other prior art shortcomings by providing a training arrangement and a method for training flight attitudes of aircrafts capable of vertical takeoff and/or vertical landing, with which critical flight attitudes, in particular takeoffs and/or landings on moving ground, can be realistically trained.

### SUMMARY OF THE INVENTION

According to one aspect of the present invention, a training arrangement for training flight attitudes of an aircraft capable of vertical takeoff and/or vertical landing includes at least one first support for at least one subject, a ground contact device at least indirectly connected with the first support, a movement device constructed as a robot with serial kinematics and substantially rigidly connected with the first support for moving the first support in at least six three-dimensional degrees of freedom, at least one control device configured for at least indirect interaction of the subject with the movement device, and a movable platform from which the ground contact device can be lifted off or onto which the ground contact device can be set down. The platform can be automatically adjusted in a predetermined fashion.

According to another aspect of the invention, a method for training flight attitudes of an aircraft capable of vertical takeoff and/or landing with a training arrangement having a movement device constructed as a robot with serial kinematics, includes the steps of controlling at least indirectly with at least one control device a movement of a first support for at least one subject, said support arranged on the movement device, moving a platform in a predetermined fashion, and operating the at least one control device so as to lift off from the moved platform a ground contact device connected at least indirectly with the first support or to set down the ground contact device onto the moved platform.

In this way, critical flight attitudes, particularly takeoff and/or landing of an aircraft capable of vertical takeoff and/or vertical landing, such as a helicopter, can be realistically simulated. When training with a training arrangement according to the invention, the subject is forced to perform a realistic “takeoff” or a “landing”, meaning to actually lift the skids or the landing gear of the aircraft off the ground and set them again down on the ground. All accelerations and bumps as well as the view from the aircraft correspond to the actual attitudes during takeoff and/or landing of an actual aircraft in actual operation. In particular, taking off and/or landing an aircraft capable of vertical takeoff and landing on a moving ground, for example the landing pad on a ship which moves in heavy seas can be realistically simulated, wherein handling of the aircraft, as well as the view from the aircraft, corresponds to the actual conditions in a realistic situation. With the realistic simulation and the possibility to implement the simulation at lower costs and more intensively than in actual flight hours, the training level of the pilot is enhanced, thereby significantly reducing the risk of an accident during the actual operation of an actual aircraft.

In addition, takeoff and landing of the aircraft on the moving platform with a training arrangement according to the invention, receiving and discharging of passengers and/or freight on the moving platform can also be trained. For example, discharging and/or receiving a physician, rescuer and or injured person on a moving ship or a train, for example by using a winch, can also be trained. Such situations, wherein in addition to steering the aircraft, an external load must also be controlled under actual visual conditions, can presently not be handled by conventional flight simulators.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a first preferred embodiment of a training arrangement according to the invention with a movement device in a first position, in an axonometric diagram;

FIG. 2 shows the training arrangement according to FIG. 1 in a lateral cross-section, with the movement device in a second position;

FIG. 3 shows the training arrangement according to FIG. 2 in an axonometric diagram;

FIG. 4 shows the training arrangement according to FIG. 2 in a plan view;

FIG. 5 shows a second preferred embodiment of a training arrangement according to the invention with the movement device in a third position, in an axonometric diagram;

FIG. 6 shows a third preferred embodiment of a training arrangement according to the invention with the movement device in a fourth position, in an axonometric diagram;

FIG. 7 shows the training arrangement according to FIG. 6 in a plan view;

FIG. 8 shows a detail of the training arrangement according to FIG. 6 in a lateral cross-section;

FIG. 9 shows a detail of the training arrangement according to FIG. 5 in a lateral cross-section, with the movement device in a fifth position; and

FIG. 10 shows the training arrangement according to FIG. 9 in an axonometric diagram.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

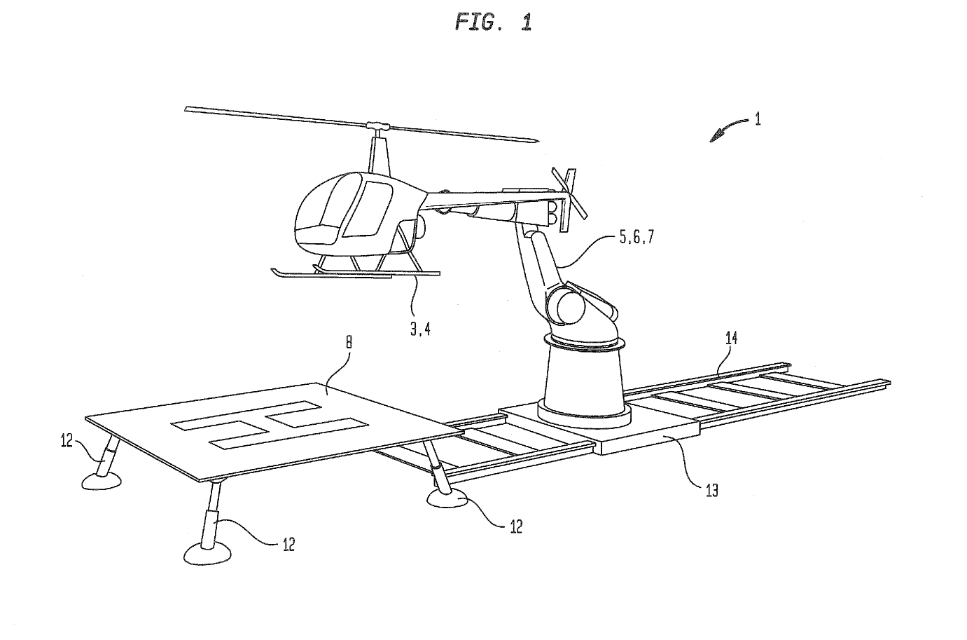

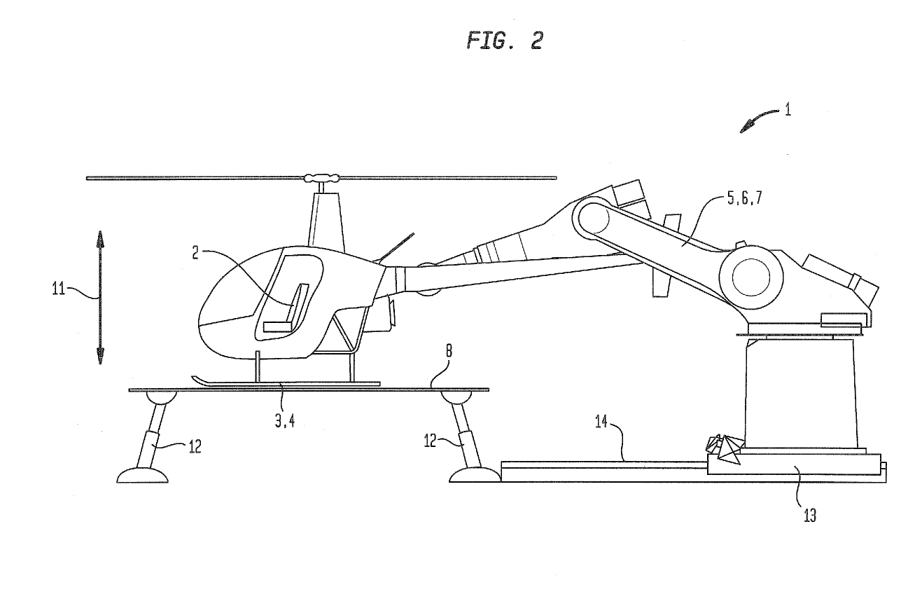

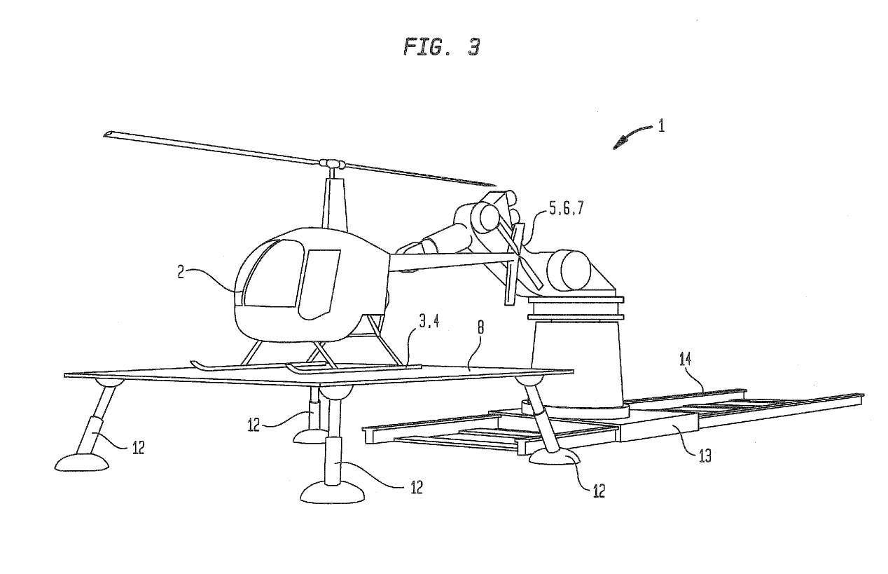

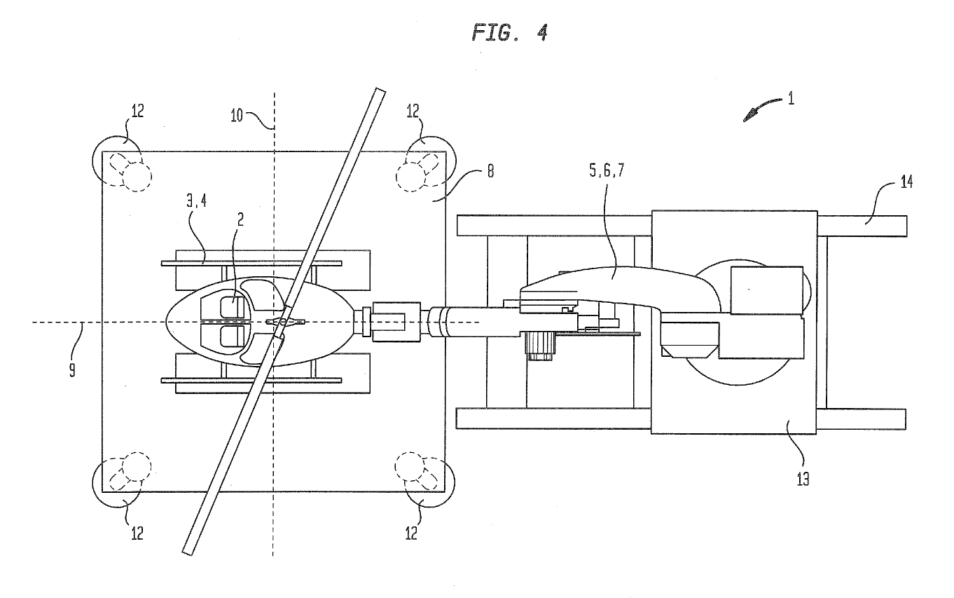

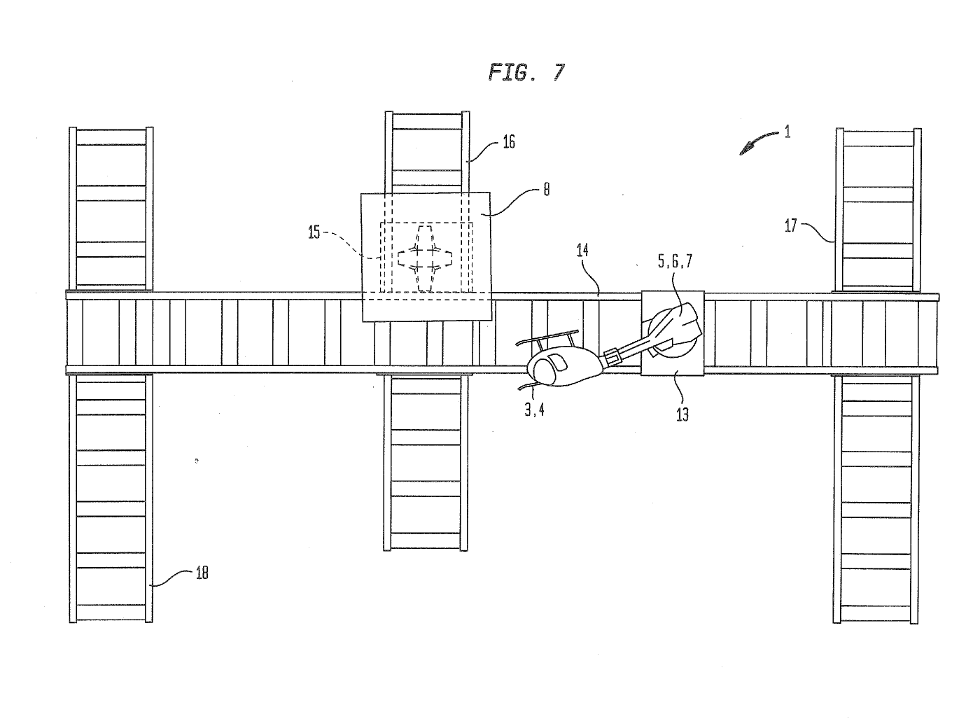

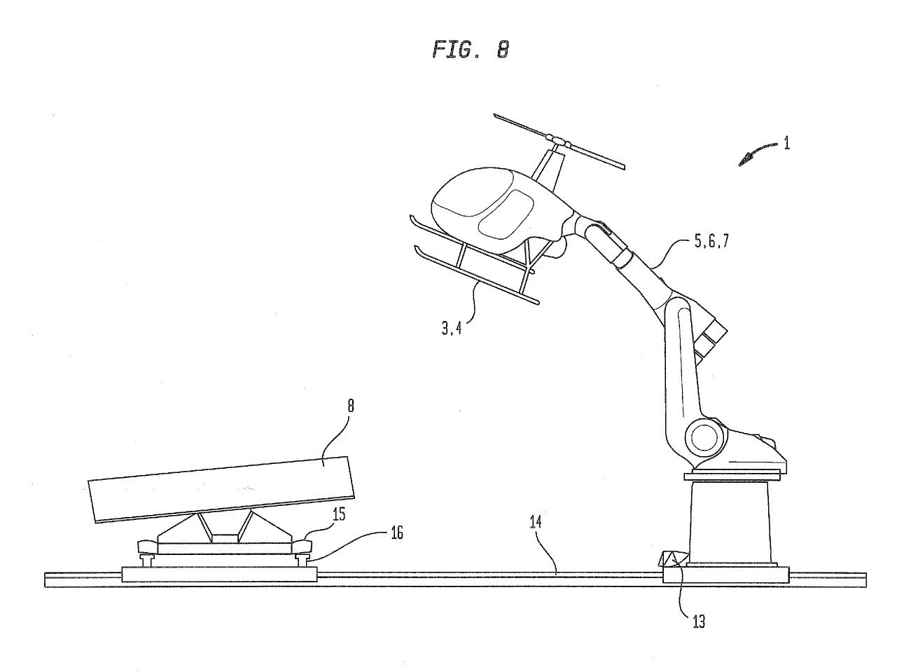

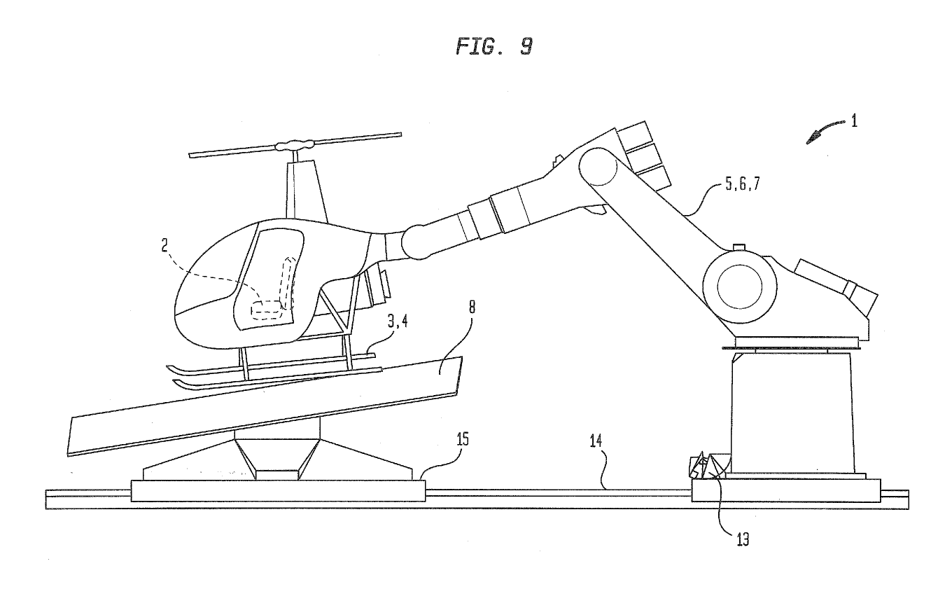

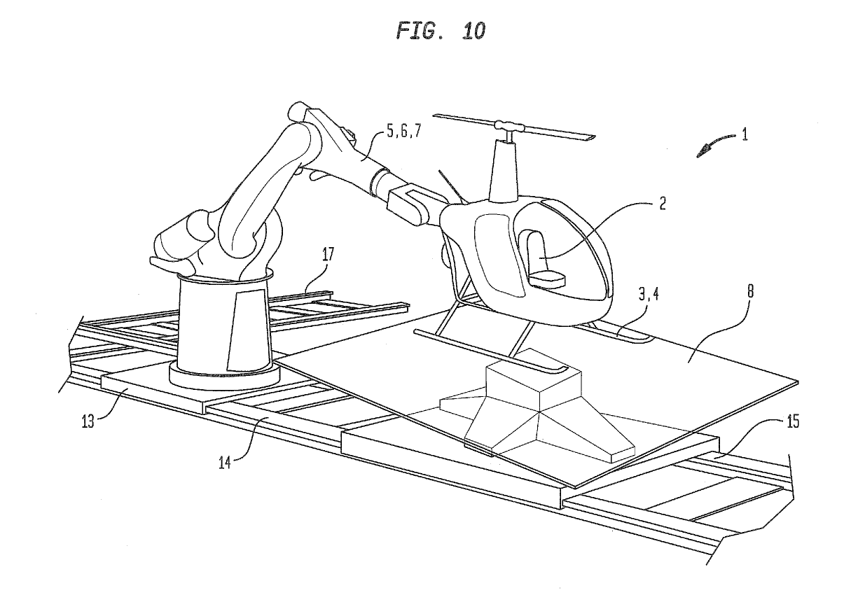

Turning now to the drawing, FIGS. 1 to 10 show particularly preferred embodiments of the training arrangement 1 for training flight attitudes of an aircraft capable of vertical takeoff and/or landings, including at least a first support 2 for at least one subject, a ground contact device 3, for example the skids 4 and/or a landing gear, a movement device 5 and at least one control device, wherein the first support 2 is essentially rigidly connected with the movement device 5, wherein the ground contact device 3 is at least indirectly connected with the first support 2, wherein the movement device 5 is constructed as a robot 6, in particular as an industrial robot 7, with serial kinematics for moving the first support 2 in at least six three-dimensional degrees of freedom, and wherein the control device is configured for at least indirect interaction of the subject with the movement device 5, wherein the training arrangement 1 includes a platform 8 for lifting off and/or setting down the ground contact device 3, and wherein the platform 8 is movable, preferably automatically adjustable in a predetermined fashion.

In this way, critical flight attitudes, in particular takeoff and/or landing of an aircraft capable of vertical takeoff and/or vertical landing, for example a helicopter, can be realistically simulated. During training with a training arrangement 1 according to the invention, or with the method of the invention, a subject is forced to realistically perform a “takeoff” and/or a “landing”, meaning to actually lift the skids 4 or the landing gear of the aircraft off the ground and set them again down on the ground. All accelerations and bumps as well as the view from the aircraft correspond to the actual conditions during takeoff and/or landing of an actual aircraft during actual operation. Due to the realistic simulation and the possibility to implement the simulation at lower costs and with more intensity than in actual flight hours, the training level of the pilot is enhanced, thereby significantly reducing the risk of an accident during the actual operation of actual aircrafts.

In addition to takeoffs and landings of the aircraft on the moving platform 8, receiving and discharging passengers and/or freight from or on the moving platform 8 can also be trained. For example, discharging and/or receiving a physician, rescuer and or an injured person on a moving ship or a train, for example by using a winch, can also be trained. Such situations, wherein in addition to steering the aircraft, an external load must also be controlled under actual visual conditions, are presently not possible with conventional flight simulators.

In this way, environmental damage from noise and contaminants can also be reduced. Training arrangements 1 according to the invention can also be arranged in a no-fly zone over in a quiet section of a historic city center. Such facilities are not tied to conventional airports or a landing platform located, for example, on a ship. Approaching a ship in heavy seas can then also be trained inland or in the desert.

The training arrangement 1 according to the invention is preferably provided for simulating essentially all movements to which humans can be exposed in an aircraft and which humans can controllably affect. The term aircraft capable of vertical takeoff and/or vertical landing preferably includes any type of aircraft capable of taking off or lifting off vertically, and/or landing vertically, i.e., setting down on the ground or a support surface. More particularly, this term includes all types of so-called VTOL aircrafts (VTOL—Vertical Take-Off and Landing), meaning all types of helicopters, but also aircraft like the Harrier, the F-35 or the Jak-38, or tilt-rotor aircrafts, such as the V-22, as well as gyrocopters. Hereinafter, preferably only the term aircraft is used which is intended to include all the aforementioned aircraft types.

A training arrangement 1 according to the invention includes at least a first support 2 for at least one subject, which can be any type of first support 2 for a subject. The term subject in this context refers to the “pilot”, i.e., the person which trains, learns and/or practices the handling of the respective aircraft with a training arrangement 1 according to the invention. Preferably, the first support 2 is embodied as a pilot seat commensurate with the type of the aircraft to be simulated.

A predetermined number of first seats 2 can be provided, wherein a “passenger” may be accommodated in addition to the subject controlling the aircraft to be simulated. For example, the predetermined number of first seats 2 may be part of a cockpit, a cockpit model or a fuselage model of an aircraft, so that the simulation can be particularly realistic, because the control elements and control devices in such an arrangement are arranged according to the aircraft to be simulated and can therefore be realistically operated.

The first support 2 is essentially rigidly connected with a movement device 5, or in the movement device 5 is constructed for moving the first support 2 in at least six three-dimensional degrees of freedom. The first support 2, and the subject located in the seat, can be essentially freely moved by the movement device 5—within the adjustment capabilities of the movement device 5. The subject can then be moved and exposed to accelerations in ways not possible with conventional simulators. According to the invention, the movement device 5 is configured as a robot 6, in particular an industrial robot 7 with serial kinematics. Such industrial robots 7 with serial kinematics are produced in many configurations and employed in automated production. Preferably, the industrial robot 7 is constructed as an articulated arm robot with serial kinematics, in particular as articulated arm robot with at least six adjustable axes. An articulated arm robot of this type has at least one robotic arm, which includes a predetermined number of partial arms connected by joints. FIGS. 1 to 10 show, for example, a preferred embodiment of such industrial robot 7 with serial kinematics embodied as a so-called 6-axes articulated arm robot. The term axis here preferably refers to any axis representing a symmetry axis about which or along which adjustment is possible, meaning a rotational adjustment about an axis and/or a translational adjustment along an axis. Preferably, the joints of the articulated arm robot for the training arrangement according to the invention are electromechanically adjusted. However, these may also be adjusted hydraulically and/or pneumatically.

The term degree of freedom may be understood as degree of freedom in a strictly physical sense, meaning three translational degrees of freedom and three rotational degrees of freedom. The term degree of freedom, however, may also be understood in that each degree of freedom designates an independent movement capability of the movement device 5, meaning of the robot 6 with serial kinematics. A robot 6 with serial kinematics having six mutually independent possibilities for movement, for example the robot illustrated in FIGS. 1 to 10, therefore does not necessarily need to incorporate six physical degrees of freedom.

The training arrangement 1 according to the invention includes at least one control device for at least indirect interaction of the subject with the movement device 5. The control device is preferably adapted to the aircraft to be simulated and includes in the preferred application for training of helicopter flight a joystick, pedals as well as a lever for the collective blade adjustment of the main rotor. The control elements are hereby adapted to the aircraft to be trained. The subject can affect the behavior of the movement device 5 with the at least one control element. Preferably, this does not involve direct control of the movement device 5. Instead, the subject transmits via the at least one control element control commands to at least one computing and control unit, which controls the movement device 5 by taking into consideration the properties of the aircraft to be simulated and the corresponding situation of an actually performed training. The reaction of an aircraft typically depends on the actual flight attitudes—commensurate with the status of a training situation, for example affected by wind or wind gusts—, and is therefore taken into consideration by the computing and control unit in the control of the movement device 5.

Training arrangements 1 according to the invention may include a ground contact device 3. A ground contact device 3 represents preferably direct assemblies of an aircraft which are constructed, depending on the aircraft to be simulated, as skids 4, landing gear or a combination thereof. The term ground contact device 3, however, preferably includes also all other devices or assemblies arranged on the aircraft or its model and configured to be brought into contact with the ground or the platform 8 during a training situation. In particular, the term ground contact device 3 in this context includes additions to an aircraft, for example externally disposed attachments for stretchers, external loads of all types, preferably external loads attached with a rope or a winch on the aircraft or its model, for example freight, a stretcher or a person, for example a rescuer. The term ground contact device preferably also includes persons standing on the skids.

In the embodiment of the ground contact device 3 as skids 4 and/or landing gear, the skids 4 and/or the landing gear can be rigidly or movably connected with the first seat such that the vibrations generated during takeoff or landing, for example during lifting off from or setting down on the ground or a support surface, in particular on the platform 8, and transmitted to the first support 2 substantially corresponding to the vibrations experienced in a comparable actual aircraft. According to a particularly preferred modification of a training arrangement according to the invention, the ground contact device 3 has at least one rated-breakpoint region and/or a crumple zone to prevent damage in the region of the movement device 3 or of a fuselage model in the event of an excessively hard collision between the ground contact device 3 and the platform 8 during training. In this case, only the ground contact device 3 would suffer damage.

According to the invention, the training arrangement 1 includes a platform 8 for lifting off and/or setting down the ground contact device 3. The platform 8 may be any type of plate suited to withstand the forces produced during operation of the training arrangement 1 according to the invention, wherein the platform 8 may also be configured to offer only a small mechanical resistance, so that damage to the ground contact device 3 can be prevented in the event of an excessively strong collision between the ground contact device 3 and the platform 8. Preferably, the shape, size and configuration of the platform 8 match those of real platforms for which the flight approach should be practiced.

According to the invention, the platform 8 is movable. Movable in this context means in particular that the platform 8 is constructed and/or configured to be moved, also to be referred to as adjustment. In a particular preferred embodiment, the platform 8 can perform dynamic movements. This can be identified on a platform 8 by examining its support, suspension and the corresponding drive means. The possibility to intentionally and controllably, in particular dynamically, move the platform 8 produces the aforementioned advantages.

Preferably, the platform 8 can be moved about a horizontal first axis 9, preferably automatically in a predetermined fashion, allowing already training of an approach to a tilting or tipping platform 8. This is particularly advantageous for pilots lacking practice. In another embodiment, the platform 8 is movable, preferably also automatically in a predetermined fashion, about a horizontal second axis 10 which is different from the first axis 9 so that in combination with a movement about the first axis 9, the approach to a platform 8 which sways about two axes 9, 10 can be trained. According to another advantageous embodiment, the platform 8 can be constructed to be movable in the vertical direction 11, preferably again automatically in a predetermined fashion. In this way, an excellent simulation of the movement of a helicopter pad of a ship under various sea conditions is possible.

In particular for moving the platform 8 dynamically, the platform 8 has at least one actuator or is controlled by at least one actuator, wherein the actuator connects the platform 8 with a support structure, for example the ground or a movable second carriage 15. Such actuator can be any device which converts, in particular, an electrical input signal into a mechanical adjustment of the platform 8, for example hydraulic cylinders, electric stepper motors and/or electric linear drives. A platform 8 which is movable only about the first axis 9 may be supported on the first axis 9, with a stepper motor or a hydraulic cylinder moving the platform 8.

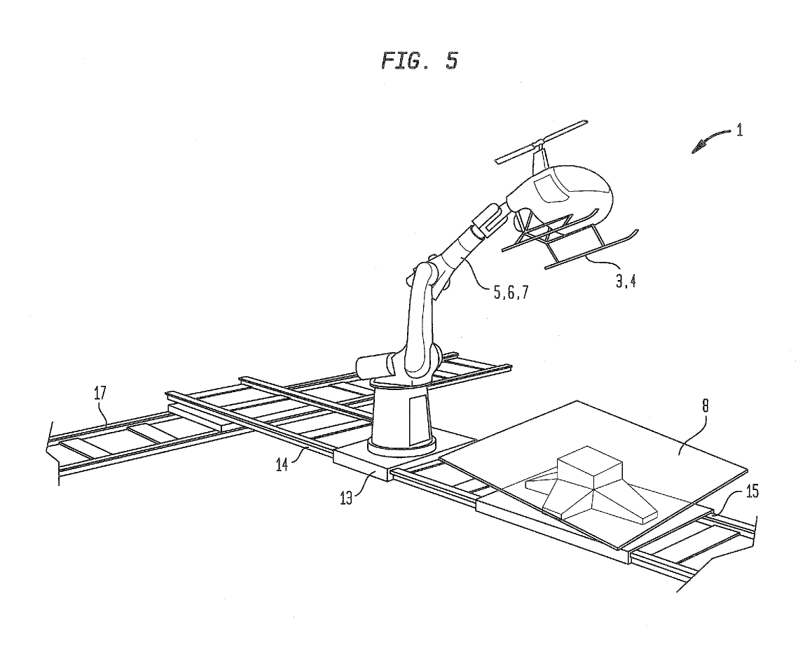

According to the preferred embodiments of a platform 8 movable in multiple dimensions, the platform 8 is connected at each of at least three spaced-apart regions to a respective linear actuator 12, in particular a hydraulic cylinder or a linear motor. FIGS. 1 to 4 show such embodiment with an additional fourth linear actuator 12. Such arrangement allows movements of the platform 8 about the first and the second axis 9, 10 as well as along a vertical direction 11, wherein all these movements may be superimposed. In another embodiment, the platform 8 is constructed as a hexapod. This allows a complete sideways motion of the platform, thereby further enhancing the demands on a pilot to be trained. FIGS. 5 to 10 only schematically illustrate the support of the platform 8.

The at least one of the linear actuator 12 or the linear actuators 12 are controlled by a computing and control unit which may be implemented as a single component with the computing and control unit that also controls the movement device 5. Preferably, the computing and control unit has stored in memory movement patterns for movement of the platform 8 and can execute these movements in a predetermined fashion, or may itself generate possible and practical movement patterns for movement of the platform 8. In a particularly preferred embodiment, the platform 8 may be moved independent of the movements of the first support 2. As a result, the “flight movements” of the simulated aircraft preferably do no affect the movements performed by the platform 8. However, for example, simulated wind gusts may affect the movements of the platform 8 as well as the movements of the simulated aircraft, meaning movement of the first support 2.

To further enhance the realism of the training, the training arrangement 1 may include at least one wind generator and/or at least one rain generator and/or at least one snow cannon. In this way, training can be made more difficult in conjunction with control of the illumination situation. Preferably, the at least one wind generator and/or at least one rain generator and/or at least one snow cannon are controlled at least indirectly by the aforementioned computing and control unit.

To improve training for the approach of the platform, according to the preferred embodiment illustrated in FIGS. 1 to 10, the robot 6 is arranged on a first carriage 13 which is supported for longitudinal displacement on a first linear guide arrangement 14. The first carriage 13 has preferably a drive unit which is preferably controlled at least indirectly by the computing and control unit. As illustrated in FIGS. 5, 6, 7 and 10, the first linear guide arrangement 14 may itself be movably supported, for example in the third and fourth linear guide arrangement 17 and 18. Preferably, the entire first linear guide arrangement 14 can be adjusted with a motor in a predetermined fashion. Alternatively, the first linear guide arrangement 14 can also be rotatable. The first carriage 13 forms in the preferred embodiments illustrated in FIGS. 1 to 10 also the support for the movement device 5 and must therefore to be constructed to be able to absorb the expected forces and moments.

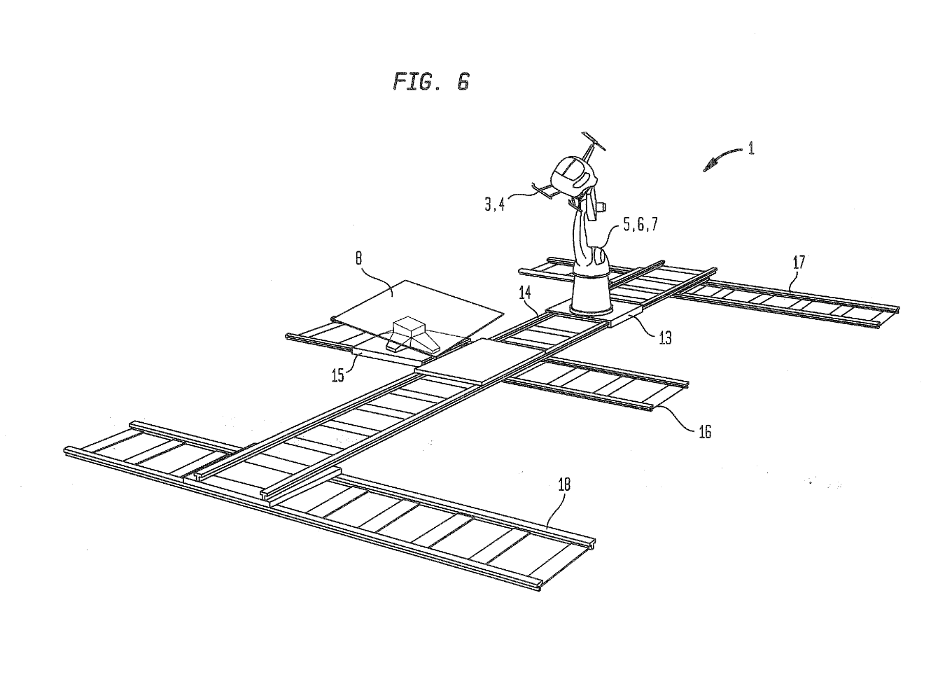

In order to further augment the coverage of possible flight attitudes and approach situations to be trained, the platform 8 may be arranged on a second carriage 15, wherein the second carriage 15 is supported on a second linear guide arrangement 16 for longitudinal displacement, wherein the second linear guide arrangement 16 is preferably also movably arranged on the first linear guide arrangement 14, as illustrated in FIG. 6. Preferably, the second carriage 15 has also at least one drive unit and is controlled, particularly indirectly, by the computing and control unit. The second carriage 15 also forms the preferred abutment for the linear actuators 12.

FIGS. 1 to 10 illustrate different preferred embodiments of a training arrangement 1 according to the invention, wherein the movement device 5 is implemented as an articulated arm robot which supports part of a fuselage of a helicopter, with the first support 2 in form of the pilot seat arranged in the fuselage. In addition, a second seat is arranged in the fuselage. The articulated arm robot is mounted on a respective carriage 13 and can be translated therewith.

The invention also relates to a method for training flight attitudes of aircraft capable of vertical takeoff and/or vertical landing, with a training arrangement 1 having a movement device 5 embodied as a robot 6 with serial kinematics, in particular a training arrangement 1 according to the invention, wherein movements of a first support 2 located on the movement device 5 for at least one subject can be controlled with at least one control device, wherein a platform 8 can be moved in a predetermined fashion, wherein the at least one control device is operated by a subject located in the first support 2 such that a ground contact device 3 connected with the first support 2 is lifted from the moving platform 8 or set down on the moving platform 8.

The aforementioned advantages can be attained with this method. As already mentioned in conjunction with the description of the apparatus, the platform 8 can be moved in a predetermined fashion about a horizontal first axis 9. In a modification of the invention, the platform 8 can be moved in a predetermined fashion about a horizontal second axis 10 which is different from the first axis 9. Independent from the movements about the first or the second axis 9, 10, the platform 8 is preferably movable in a vertical direction 11 in a predetermined fashion.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A training arrangement for training flight attitudes of an aircraft capable of vertical takeoff and/or vertical landing, comprising:
at least one first support for at least one subject,
a ground contact device at least indirectly connected with the first support,
a movement device constructed as a robot with serial kinematics and substantially rigidly connected with the first support for moving the first support in at least six three-dimensional degrees of freedom,
at least one control device configured for at least indirect interaction of the subject with the movement device, and
a movable platform from which the ground contact device can be lifted off or onto which the ground contact device can be set down, wherein the platform is automatically adjustable in a predetermined fashion.

2. The training arrangement of claim 1, wherein the ground contact device comprises skids or a landing gear, or both.

3. The training arrangement of claim 1, wherein the robot is an industrial robot.

4. The training arrangement of claim 1, wherein the platform is movable about a horizontal first axis.

5. The training arrangement of claim 1, wherein the platform is movable about a horizontal second axis different from the horizontal first axis.

6. The training arrangement of claim 1, wherein the platform is movable in a vertical direction.

7. The training arrangement of claim 1, further comprising linear actuators, wherein the platform is connected in each of at least three spaced-apart regions to a corresponding linear actuator.

8. The training arrangement of claim 7, wherein the linear actuator comprises a hydraulic cylinder or a linear motor.

9. The training arrangement of claim 7, wherein the platform is constructed as a hexapod.

10. The training arrangement of claim 1, further comprising:
a first carriage on wherein the robot is arranged, and
a first linear guide arrangement supporting the first carriage for longitudinal displacement thereon.

11. The training arrangement of claim 1, further comprising:
a second carriage on wherein the platform is arranged, and
a second linear guide arrangement supporting the second carriage for longitudinal displacement thereon.

12. The training arrangement of claim 10, wherein the first carriage comprises at least one drive unit.

13. The training arrangement of claim 10, wherein the second carriage comprises at least one drive unit.

14. The training arrangement of claim 1, wherein the ground contact device has at least one rated-breakpoint region or a crumple zone, or both.

15. The training arrangement of claim 1, comprising at least one wind generator, at least one rain generator or at least one snow cannon, or a combination thereof.

16. A method for training flight attitudes of an aircraft capable of vertical takeoff and/or landing, with a training arrangement having a movement device constructed as a robot with serial kinematics, comprising the steps of:
controlling at least indirectly with at least one control device a movement of a first support for at least one subject, said support arranged on the movement device,
moving a platform in a predetermined fashion, and
operating the at least one control device so as to lift off from the moved platform a ground contact device connected at least indirectly with the first support or to set down the ground contact device onto the moved platform.

17. The method of claim 16, wherein the platform is moved independent of the movement of the first support.

18. The method of claim 16, wherein the platform is moved about a horizontal first axis in a predetermined fashion.

19. The method of claim 18, wherein the platform is moved about a horizontal second axis which is different from the horizontal first axis.

20. The method of claim 16, wherein the platform is moved in a vertical direction.
